(19) United States
(12) Patent Application Publication
(10) Pub. No.: US 2010/0019741 A1
(43) Pub. Date: Jan. 28, 2010

(54) CIRCUIT ARRANGEMENT AND METHOD FOR REGULATING THE CURRENT IN AN ON-BOARD ELECTRICAL POWER SUPPLY SYSTEM OF A VEHICLE

(75) Inventors: Karl-Hermann KETTELER, Markdorf (DE); Mesut ER, Friedrichshafen (DE); Juergen KETT, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/507,441

(22) Filed: Jul. 22, 2009

(30) Foreign Application Priority Data
Jul. 23, 2008 (DE) 10 2008 040 625.2

(51) Int. Cl. G05F 1/613

(52) U.S. Cl. 323/223

(57) ABSTRACT

A circuit arrangement for regulating the current in an on-board electric power supply system of a vehicle, with a controllable damping resistance, an energy accumulator and an electronic control unit. The damping resistance is adjustable to satisfy a control condition, such that generator current flowing through the control unit can be compensated by a counter-current originating from the energy accumulator and flowing through the damping resistance, having regard to a specified current limit value. In a method for controlling the circuit arrangement, generator current flowing through the control unit is compensated by a counter-current originating from the energy accumulator and flowing through the damping resistance, and the damping resistance is controlled, in such a manner, that a predetermined current limit value is taken into account.

This application claims priority from German patent application serial no. 10 2008 040 625.2 filed Jul. 23, 2008.

### FILED OF THE INVENTION

The invention concerns a circuit arrangement for regulating the current in an on-board electrical power supply system of a vehicle and a method for controlling a circuit arrangement for regulating the current in an on-board electrical power supply system of a vehicle.

### BACKGROUND OF THE INVENTION

The continuing electrification in vehicles, with on-board electrical power supply systems that comprise numerous consumers of electric power with ranging energy demands and in which both motor and generator currents flow, demands an energy management system that is becoming increasingly complex. On the one hand, the electrical energy available should be used as efficiently and effectively as possible, so that perfect functionality of the electrical system itself and of the electricity consumers connected to it must be ensured. On the other hand the electrical system has to be protected against overloads or undersupply at all times.

For example, in more recent vehicle designs roll stabilization systems with electromechanical actuators, known as “eARS” (electromechanically Active Roll Stabilization) or “ERC” (Electromechanical Roll Control) systems, are provided. As is known, with a roll stabilization system stabilizers act by means of torsional moments on the suspension of the vehicle body in order to reduce lateral rolling movements of the vehicle when driving round curves and on stretches of bad road. In the case of active roll control the stabilizers are regulated by actuators in such manner that on the one hand the lateral inclination of the vehicle body is considerably reduced when driving round curves and on the other hand comfortable, soft response behavior is obtained when driving straight ahead. In contrast to conventional, hydraulic actuators, electromechanical actuators have a particularly compact structure owing to the absence of hydraulic components. In addition, for energy-saving reasons they can operate according to the “power-on-demand” principle, so that a brief current requirement of a “power-on-demand” system connected to the on-board electrical system is only called for by specific actuation, so that on average, less energy is consumed.

From DE 102 57 211 A1 an active roll stabilization system with an electromechanical actuator is known, which can be controlled so as to brace two stabilizer components relative to one another. For emergency operation in the event that the roll control system should fail, the electric motor of the actuator can also be operated as a generator by short-circuiting the motor phases. This applies a resistance torque between the rotor and stator of the electric machine, which damps the stabilizer components relative to one another, thus maintaining a limited, passive stabilizer function if there is a system failure.

Such emergency operation in a roll stabilization system with electromechanical control drives is only mentioned, for example, for the occurrence of generator currents in the on-board power supply system that can result in problematic current flows. Rather, in stabilization systems with electromechanical control drives, even during regular operation both motor and generator operating modes occurring at the same time or in alternation can be available. In this it is decisive that such currents, possibly from different sources and often emitted by generator energy feedbacks via electronic control units in intermediate circuits, can be relatively large. Thus, in many modern and future on-board electrical system configurations current-limiting measures in the processing of generator system-loads are needed.

In DE 102 26 308 Al by the present applicant, possibilities for the reduction of excess electrical energy in an on-board electrical power supply system are described. Among other things, a power electronics system of comparatively large size can consume current by virtue of short-circuit switching and convert it into heat. Furthermore, a so-termed braking chopper is suitable for passing excess current through a resistor, by which it is converted to heat.

In circuit arrangements with electromechanical actuators, which are operated for example by a pulse emitter or DC/AC mutation in an intermediate circuit of the on-board system, during generator-mode braking electric currents that must be reduced can be produced by energy feedback. With such circuit arrangements, for reasons of cost and fitting space measures for controlling and limiting the current should be implemented with the least possible expenditure on components and control electronics. On the other hand permanent monitoring of the current in the on-board system by means of one or more current sensors, for continuous determination of the actual value of currents in order to recognize inadmissible deviations and if necessary adopt countermeasures, is relatively elaborate and costly.

### SUMMARY OF THE INVENTION

Against this background the purpose of the present invention is to develop a circuit arrangement for an on-board electrical power supply system of a vehicle and a method for its control, which with the least possible complexity and cost, enable effective processing of generated currents with regard to current-limiting regulation.

The invention is based on the recognition that a generated current that affects the electrical system of a vehicle, via the control electronics of an electromechanical actuator, can be compensated by an opposed battery current from an energy accumulator flowing through a damping resistance, the damping resistance being controllable by a field-effect transistor in such manner that a given electric system current level is maintained or that the current does not fall below that level.

Accordingly, the invention starts from a circuit arrangement for regulating the current in an on-board electric power supply system of a vehicle, with controllable damping resistance, an energy accumulator and an electronic control unit. To achieve the stated objective the invention provides that to fulfill a control condition the damping resistance is adjustable, so that a generator current flowing through the control unit can be compensated by a counter-current originating from the energy accumulator and flowing through the damping resistance, having regard to a predetermined current limit value.

In addition, the invention starts from a method for controlling a circuit arrangement in an on-board electric power supply system of a vehicle, with a controllable damping resistance, an energy accumulator and an electronic control unit. The set objective relating to method is achieved in that a generator current flowing through the control unit is compensated by a counter-current originating from the energy accumulator and flowing through the damping resistance, the damping resistance being controlled in such manner that a predetermined current limit value is taken into account.

In the circuit arrangement a braking chopper is used in an intermediate circuit of an actuator control unit. The braking chopper consists of a field-effect transistor, advantageously a MOSFET (Metal-Oxide Semiconductor Field Effect Transistor) and an ohmic resistance. The braking chopper constitutes an adjustable damping resistance which can be controlled by a control unit, also referred to below as ECU (Electronic Control Unit). The principle of a braking chopper's mode of operation and its structure are known per se to those familiar with the subject. The ECU controls the damping MOSFET with a suitable cycle frequency that ensures sufficiently high response dynamics.

The control is continuously adjustable in accordance with the relation:

$${R}_{Brems} = \frac{{R}_{1}}{a}$$

in which R₁ is the ohmic resistance and 0≦a≦1 is the relative pulse width. Here, it is assumed that the current flowing through the damping resistance is proportioned to voltage. To achieve this, the braking chopper is made with the lowest possible inductivity. An otherwise usual bypass diode is omitted.

Correspondingly, with pulse-width-modulated control the current strength in the power supply system can range between zero and a maximum value with relatively high gradient. To counteract this, additional filtering means can be connected at the interfaces with the power system.

According to the invention, a control condition is provided for the adjustable damping resistance. According to this, a generator-originated ECU current is compensated by a counter-current flowing through the damping resistance from an energy accumulator, for example from the vehicle's battery. To ensure that during this the power supply current is certain not to fall below a limit value, i.e. that I_{Bat}>−Iₗᵢₘ at all times, the damping resistance is controlled in accordance with the relation:

$${R}_{Brems} = - \frac{{U}_{Bat} + {I}_{lim} * ( {R}_{bat} + {R}_{Kabel} )}{{I}_{lim} + {I}_{ECU}}$$

in which R_{Brems}=damping resistance value, U_{Bat}=energy accumulator voltage, R_{Bat}=internal resistance of the energy accumulator, R_{Kabel}=resistance of input lead, Iₗᵢₘ=current limit value and I_{ECU}=current in the control unit. In the above, the imposed ECU current has its sign reversed, i.e. it is taken as negative.

As a secondary condition it must be ensured that for currents I_{ECU}≧−Iₗᵢₘ the damping resistance branch is switched open. The battery current flowing through the ECU can be calculated relatively easily from the motor currents of the actuators in the ECU. Since the battery current is known and the internal and cable resistances are predetermined as constants, the damping resistance can be varied comparatively simply in accordance with the above limit value condition. This has the advantage that there is no need for relatively complex current sensor means which feed a limit control system with the instantaneous actual value of the power supply current, as a result of which a derivation of generator currents would also be possible.

In this arrangement the mean damping branch current can be calculated from the relation:

$${I}_{Brems} = - \frac{{U}_{Bat} - {I}_{ECU} * ( {R}_{Bat} + {R}_{Kabel} )}{{R}_{Bat} + {R}_{Kabel} + {R}_{Brems}}$$

From this it is evident that the largest fraction of the damping branch current results from the battery voltage. Only a smaller fraction corresponds to the ECU current. Thus, in deriving the generator current considerable power losses P_{Brems}=I²_{Brems}R_{Brems} can occur in the damping branch, which enables the compensation of comparatively high generator current strengths.

Furthermore, safety measures can be provided for the event that the field-effect transistor of the damping resistance fails. As a simple safety measure, the low-ohm resistance can be connected directly to the battery voltage branch, whereby the current produced can flow away directly. Since failure of the field-effect transistor can lead to failure of the system as a whole, as a supplementary safety measure it is expedient to connect in series a second, redundant field-effect transistor. In addition, on-going diagnosis of the damping resistance in relation to its contacts and its respective resistance value for the purpose of monitoring its functionality and for early defect recognition is advantageous. For example, a partial voltage value could be tapped off the damping resistance, which can be used in a manner comparable to the high level of a digital input.

The circuit arrangement according to the invention is based on a concept investigation on roll stabilization. Measurement series and field tests have shown that by means of a continuously adjustable damping resistance that satisfies the control condition, essentially any generator-originating roll stabilization currents that occur in practical driving operation can be controlled with the help of the damping resistance. Thus, the invention can be used to particularly good effect in vehicles so equipped, but it is not limited to applications related to such systems, but rather, is fundamentally suitable for controlling a damping resistance to limit generator currents in the on-board power supply system.

### BRIEF DESCRIPTION OF THE DRAWINGS

To clarify the invention, the description of a drawing representing an example embodiment is given below:

FIG. 1: Principle of a circuit for controlling a damping resistance for the processing of generator currents in an on-board electric power supply system;

FIG. 2: Damping resistance diagram of a circuit arrangement according to the invention; and

FIG. 3: Power loss diagram of a circuit arrangement according to the invention.

### DETAILED DESCRIPTION OF THE PREFERRED EMBODIMENTS

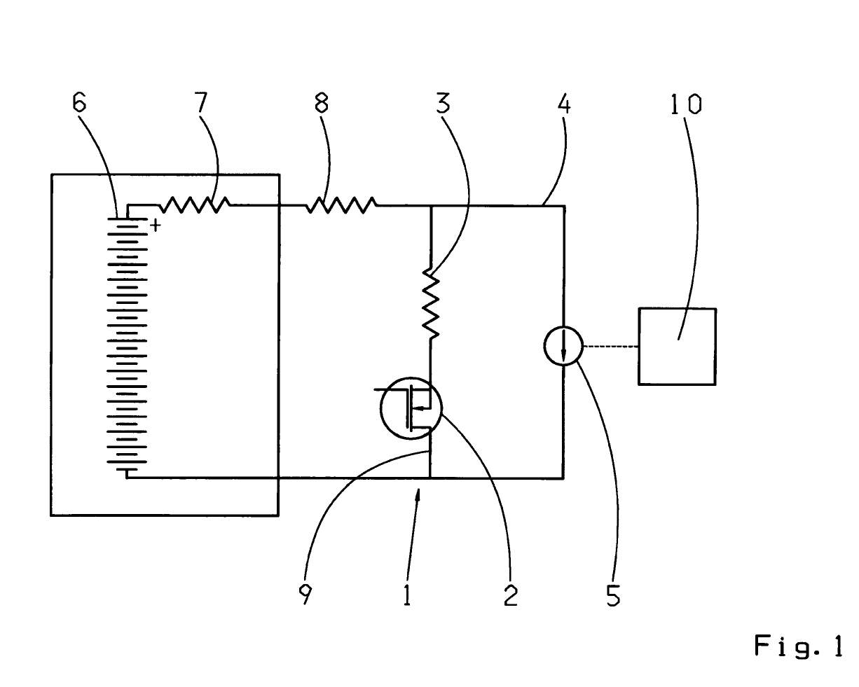

Accordingly, FIG. 1 shows a circuit arrangement in an on-board electric power supply system of a motor vehicle, with a damping resistance 1 made as a braking chopper, which consists of a MOSFET 2 and an ohmic resistance 3. The damping resistance 1 is connected into a damping branch 9, which is part of an intermediate circuit 4 of a control unit (ECU) 5 for controlling one or more actuators (not shown) of a roll stabilization system 10. The intermediate circuit 4 is connected to an energy accumulator 6 of the power supply system, for example a 24-V vehicle battery. In addition, an internal resistance 7 of the battery 6 and a further resistance 8 of the electric lead to the intermediate circuit 4 are indicated, for each of which a value of 20 mΩ can be assumed as an example.

The ECU 5 delivers an imposed current I_{ECU} The value R_{Brems} of the damping resistance 1 can be continuously adjusted by cycled control of the MOSFET 2 in accordance with the equation:

$${R}_{Brems} = \frac{{R}_{1}}{a}$$

in which R₁ is the value of the ohmic resistance 3 and the value a is the modulation, i.e. the relative pulse width of the MOSFET 2, which can have values of 0≦a≦1, such that the current flow varies in the power system in accordance with a voltage-pulse width modulation provided for the control.

Thus, with complete voltage proportionality the current strength can vary between zero and a maximum value. To avoid unacceptably large current fluctuations d1/dt, additional electronic filtering means (not shown) are provided if necessary. For example, an electrolytic condenser associated with the ECU 5 can be used as a filtering component.

During operation of the electromechanical roll stabilization system 10 a generator current of the ECU 5 is compensated by a counter-current from the battery 6 flowing through the damping resistance 1, the damping resistance 1 being controlled in accordance with the relation:

$${R}_{Brems} = - \frac{{U}_{Bat} + {I}_{lim} * ( {R}_{bat} + {R}_{Kabel} )}{{I}_{lim} + {I}_{ECU}}$$

so that with a typical limit value of 15 A, the power supply current does not fall below the value I_{Bat}>−15 A. Accordingly, with the above values the damping resistance obtained is:

$${R}_{Brems} = - \frac{24 V + 15 A * 0.04 Ω}{15 A + {I}_{ECU}}$$

in which in the first place the sign of the imposed current I_{ECU} should be noted and in the second place, because of the validity range of the equation when I_{ECU}>−15 A, the damping branch 9 must be open.

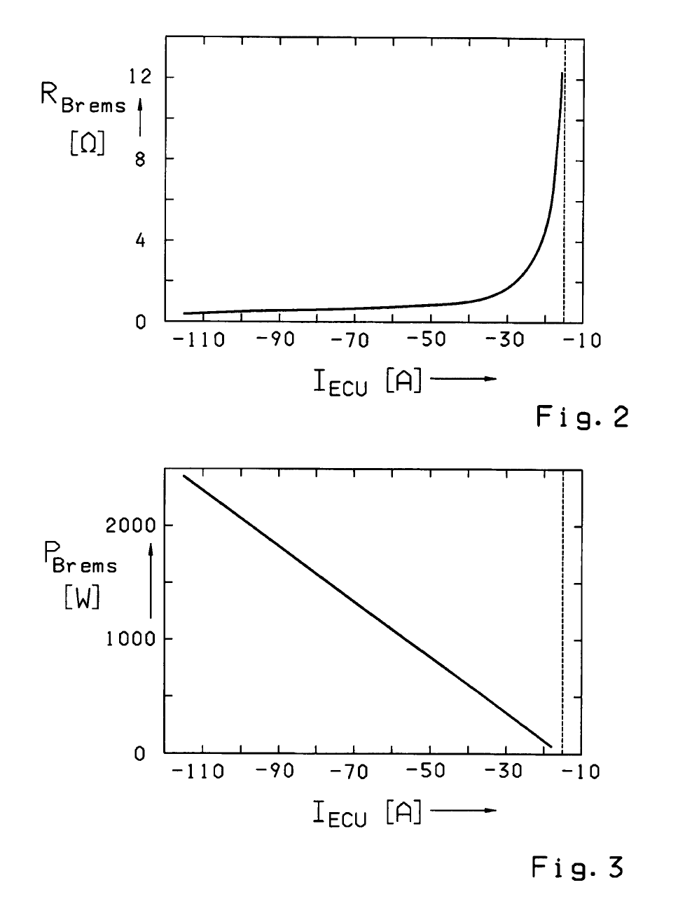

FIG. 2 shows a variation of the resulting value of the cycled damping resistance 1. In the damping resistance diagram a steeply converging increase of the damping resistance value R_{Brems} as the current limit value Iₗᵢₘ=15 A is approached can be seen, while with larger generator currents a correspondingly higher counter-current flows and the necessary damping resistance 1 approaches zero, i.e. as the relative pulse width a increases it is controlled downward. If an ohmic resistance 3 with a typical resistance value R₁=0.3Ω is chosen for the damping resistance 1, then with a relative pulse width of a=0.55 of the damping MOSFET 2 a generator current of 60 A can be compensated without problems, and there is even an under-voltage reserve.

If in the above example one considers the mean damping branch current:

$${I}_{Brems} = - \frac{{U}_{Bat} - {I}_{ECU} * ( {R}_{Bat} + {R}_{Kabel} )}{{R}_{Bat} + {R}_{Kabel} + {R}_{Brems}} = - \frac{24 V - {I}_{ECU} * 0.04 Ω}{0.04 Ω + {R}_{Brems}}$$

considerable power losses P_{Brems}=I²_{Brems}R_{Brems} in the kW range can occur in the damping branch 9, as can be seen in the power loss diagram of FIG. 3. As a result of the course of the damping resistance R_{Brems} the variation of the power loss P_{Brems} with ECU current decreases linearly.

In early field tests with a roll stabilization system 10 with two actuators, to which the current limit I_{Bet}>−(7.5 A+7.5 A) was distributed, it was possible to verify the effectiveness of the control of the adjustable damping resistance 1 according to the invention with the above example component layout of the circuit arrangement. On a stretch of bad road, on average an electric battery power of around 30 W to 40 W was dissipated in the damping resistance 1, with power peaks of around 2 kW. In contrast, along a slalom course the damping resistance 1 was hardly loaded at all and it therefore took up no additional battery power. Accordingly, the circuit arrangement according to the invention is well capable of dissipating effectively and safely, the generator currents that occur in practical operation.

### LIST OF INDEXES

1 Damping resistance, braking chopper
2 Field-effect transistor, MOSFET
3 Ohmic resistance
4 Intermediate circuit
5 Control unit, ECU
6 Energy accumulator, vehicle battery
7 Internal resistance of the battery
8 Resistance of the input lead
9 Damping branch
10 Roll stabilization
a Pulse width
I_{Bat} Battery current
I_{Brems} Damping current
I_{ECU} Control unit current
Iₗᵢₘ Current limit value
P_{Brems} Damping power loss
R₁ Ohmic resistance value
R_{Bat} Value of battery internal resistance
R_{Brems} Damping resistance
R_{Kabel} Value of input lead resistance
U_{Bat} Battery voltage

1-12. (canceled)

13. A circuit arrangement for regulating current in an on-board electric power supply system of a vehicle, the circuit arrangement comprising a controllable damping resistance (1), an energy accumulator (6) and an electronic control unit (5),
the damping resistance (1) being adjustable to fulfill a control condition so that a generator current, flowing through the electronic control unit (5), is compensated by a counter-current originating from the energy accumulator (6) and flowing through the damping resistance (1), having regard to a predetermined current limit value.

14. The circuit arrangement according to claim 13, wherein the control condition is expressed by the formula:
$${R}_{Brems} = - \frac{{U}_{Bat} + {I}_{lim} * ( {R}_{bat} + {R}_{Kabel} )}{{I}_{lim} + {I}_{ECU}}$$
wherein R_{Brems}=damping resistance value,
U_{Bat}=energy accumulator voltage,
R_{Bat}=internal resistance of the energy accumulator,
R_{Kabel}=resistance of the input lead,
Iₗᵢₘ=current limit value, and
I_{ECU}=control unit current.

15. The circuit arrangement according to claim 13, where the damping resistance (1) is a braking chopper arranged in a damping branch (9) which comprises an ohmic resistance (3) and a cycled first field-effect transistor (2) that act upon the ohmic resistance (3), which are controlled by the electronic control unit (5) by a pulse-width-modulation.

16. The circuit arrangement according to claim 14, wherein the damping resistance value (R_{Brems}) is varied, by continuous adjustment of a pulse width of a field-effect transistor (2) in accordance with the formula:
$${R}_{Brems} = \frac{{R}_{1}}{a}$$
wherein R₁=ohmic resistance, and
α=relative pulse width.

17. The circuit arrangement according to claim 15, wherein the first field-effect transistor (2) is a metal-oxide semiconductor field effect transistor (MOSFET).

18. The circuit arrangement according to claim 15, wherein safety measures are provided for an event in which the first field-effect transistor (2) of the damping resistance (1) fails.

19. The circuit arrangement according to claim 18, wherein, as a safety measure, the ohmic resistance (3) of the damping resistance (1) is directly electrically connected to the energy accumulator (6) if the first field-effect transistor (2) fails.

20. The circuit arrangement according to claim 18, wherein, as a second safety measure, a second, redundant field-effect transistor is connected in series with the first field-effect transistor (2).

21. The circuit arrangement according to claim 18, wherein, as a third safety measure, a diagnosis means monitors a functionality of the damping resistance (1).

22. The circuit arrangement according to claim 13, wherein at least one control unit (5), acting as a source of generator current, is associated with at least one electromechanical actuator.

23. A circuit arrangement in combination with an on-board electric power supply system of a motor vehicle with a roll stabilization system (10) comprising at least one electromechanical actuator, a controllable damping resistance (1), an energy accumulator (6) and an electronic control unit (5), the damping resistance (1) being adjustable to fulfill a control condition so that a generator current, flowing through the electronic control unit (5), is compensated by a counter-current originating from the energy accumulator (6) and flowing through the damping resistance (1), having regard to a predetermined current limit value.

24. A method of controlling a circuit arrangement for regulating a current in an on-board power supply system of a vehicle, with a controllable damping resistance (1), an energy accumulator (6) and an electronic control unit (5), the method comprising the steps of:
compensating for a generator current flowing through the control unit (5) with a counter-current originating from the energy accumulator (6) and flowing through the damping resistance (1), and
controlling the damping resistance (1) such that a predetermined current limit value is taken into account.
